(19) United States
(12) Patent Application Publication
(10) Pub. No.: US 2010/0193356 A1
(43) Pub. Date: Aug. 5, 2010

(54) SENSOR ELEMENT AND METHOD AND MEANS FOR ITS PRODUCTION

(76) Inventors: Thomas Wahl, Pforzheim (DE); Joerg Jockel, Ceske Budejovice (CZ); Andreas Opp, Rutesheim (DE); Matthias Kruse, Stuttgart-Vaihingen (DE); Detlef Heimann, Gerlingen (DE); Frank Buse, Karlsruhe (DE); Ulrich Eisele, Stuttgart (DE); Bernd Schumann, Rutesheim (DE); Christoph Renger, Bamberg (DE); Harry Braun, Heimsheim (DE); Berndt Cramer, Leonberg (DE)

Correspondence Address: KENYON & KENYON LLP, ONE BROADWAY, NEW YORK, NY, 10004, US

(21) Appl. No.: 12/086,555

(22) PCT Filed: Nov. 29, 2006
(86) PCT No.: PCT/EP2006/069035

§ 371 Date: Apr. 16, 2010

(30) Foreign Application Priority Data
Dec. 14, 2005 (DE) 10 2005 059 594.4

(51) Int. Cl. G01N 27/407; B05D 5/12; C09D 1/00

(52) U.S. Cl. 204/432; 427/126.2; 106/286.7; 106/286.6; 106/286.1

(57) ABSTRACT

A sensor element for gas sensors is described for determining gas components of a gas mixture, especially in exhaust gases of internal combustion engines, having at least one electrochemical measuring cell and at least one porous layer that is exposed to the gas mixture. The porous layer contains palladium, platinum, ruthenium, an alkali metal and/or an alkaline earth metal, the platinum being contained in the porous layer at a minimum concentration of 1.5 wt. %. Furthermore, a method and an impregnating solution are described for producing the sensor element.

### FIELD OF THE INVENTION

The present invention relates to a sensor element for gas sensors and a method as well as an impregnating solution for producing same according to the definition of the species in the independent claims.

### BACKGROUND INFORMATION

Ceramic sensor elements may be used for determining the oxygen concentration in the exhaust gases of internal combustion engines, which are formed from a planar solid electrolyte element and may have electrochemical pump cells and/or Nernst cells. These electrochemical cells have measuring electrodes which, to the extent that they are exposed to the corrosively acting exhaust gases, demonstrate a frequently insufficient long-term durability. This shows itself in the form of a signal drift of the electrochemical measuring cell.

For the solution of this problem, a sensor element is discussed in German patent document DE 41 00 106 C1, whose measuring electrode, that is exposed to the gas mixture, is covered by a protective layer which contains catalytically active substances. This protective layer ensures a catalytic equilibrium setting of the exhaust gases diffusing to the measuring electrode, and thus ensures a relatively stable control position of the sensor element. This proposal has the disadvantage of relatively high material costs for producing the protective layer, as well as the fact that the control position is not completely stable during continuous operation. This drift is conditioned upon the production process of the sensor element, in which the protective layer, and thus also the substances contained in it, are sintered along withthe rest and have only slight catalytic activity as a result. It is an object of the exemplary embodiments and/or exemplary methods of the present invention to provide a sensor element which demonstrates good long-term stability and a stable control position, and may nevertheless be manufactured simply and cost-effectively.

### ADVANTAGES OF THE INVENTION

The sensor element according to the present invention and the method as well as the means for its production, having the features described herein may attain the object of the exemplary embodiments and/or exemplary methods of the present invention.

The sensor element has a protective layer, in this instance, which, because of its execution and material composition, demonstrates a good signal stability in continuous operation, and can nevertheless be realized in a comparatively cost-effective manner. This is achieved by developing the protective layer to be porous, and providing only its pores with selected catalytically active substances. The production of the sensor element only requires an additional impregnating process as well as an additional heat treatment, and is therefore able to be carried out in a simple manner using customary manufacturing paths.

The measures delineated in the dependent claims render possible advantageous refinements of and improvements to the sensor elements given in the independent claims, and the method as well as the means for its manufacture.

Thus, it is of advantage if the porous layer of the sensor element has in its pores, at least partially, a catalytically active coating whose material composition deviates from the material composition of the porous layer, and the palladium or ruthenium contains an alkali metal or an alkaline earth metal, for instance, in each case in the presence of platinum or palladium and/or platinum, for example, having a minimum concentration of 2 wt. %. In this context, it is particularly advantageous if the solution does not contain barium and one of the elements rubidium or cesium simultaneously, since these demonstrate reduced catalytic activity when they occur together.

Furthermore, it is advantageous if the porous layer as the protective layer, at least from place to place, covers an electrode of the sensor element, or is alternatively developed as a diffusion barrier and restricts the access of the gas mixture to an inner gas chamber of the sensor element. In this way a catalytic equilibrium setting is achieved in the gas mixture that is to be determined, before it reaches measuring electrodes of the sensor element, which may also be positioned in an inner gas chamber of the sensor element.

An exemplary embodiment of the present invention is represented in the drawing and explained in greater detail in the following description.

### BRIEF DESCRIPTION OF THE DRAWING

The FIGURE shows a cross section through a sensor element according to an exemplary embodiment of the present invention.

### DETAILED DESCRIPTION

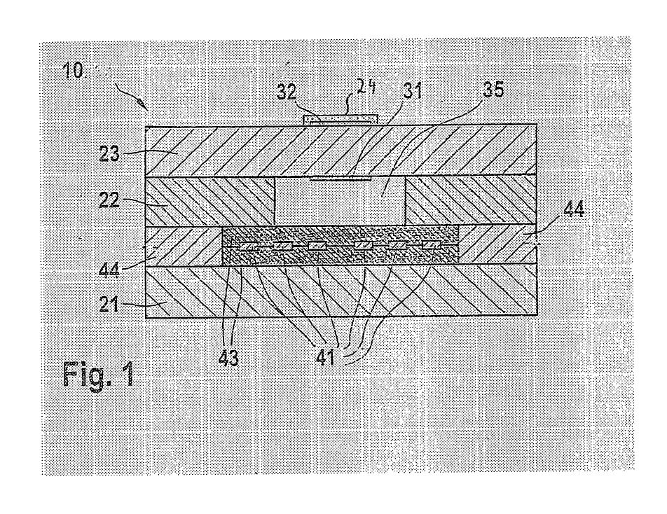

FIG. 1 shows an exemplary embodiment of sensor element 10 of the present invention. Sensor element 10 is constructed in layers and includes a first solid electrolyte layer 21, a second solid electrolyte layer 22 and a third solid electrolyte layer 23. Solid electrolyte layers 21-23 are made, in this instance, of an oxygen ion-conducting solid electrolyte material, such as ZrO₂ stabilized or partially stabilized by Y₂O₃. Sensor element 10 is installed in a gas sensor in a manner known to one skilled in the art.

Between first and second solid electrolyte layer 21, 22 a heater circuit board conductor 41 is provided, having an insulation 43. Insulation 43 is a porous layer of aluminum oxide which completely envelops heater circuit board conductor 41. Insulation 43 of heater circuit board conductor 41 is surrounded at its side, that is, in the layer plane of heater circuit board conductor 41, by a gas-tight sealing frame. Sealing frame 44 extends to the outer surface of sensor element 10.

A reference gas chamber 35 containing a reference gas has been introduced in second solid electrolyte layer 22. In reference gas chamber 35, a first electrode 31 is applied on third solid electrolyte layer 23. On the side opposite first electrode 31 of third solid electrolyte layer 23, and thus on an outer surface of sensor element 10, a second electrode 32 is provided that is exposed to the exhaust gas.

First and second electrodes 31, 32, together with solid electrolyte 23 that is positioned between the two electrodes 31, 32 form an electrochemical cell. If different partial pressures of oxygen are present at first electrode 31 (in reference gas chamber 35) and at second electrode 32 (in the exhaust gas), a voltage is developed between the two electrodes 31, 32 which is a measure for the partial pressure of the oxygen in the exhaust gas (Nernst cell). Electrochemical cell 31, 32, 23 is positioned in a measuring range 15 of sensor element 10, that is, at the end section of sensor element 10 facing the exhaust gas.

In order to ensure that a setting of the thermodynamic equilibrium of the gas mixture components takes place at electrodes 31, 32, all of the electrodes used are made of a catalytically active material, such as platinum, the electrode material for all of the electrodes being applied as cermet in a manner known per se, in order to sinter the electrode material to the ceramic foils.

In order particularly to protect outer pump electrode 32 from a direct contact with the potentially corrosively and abrasively acting gas mixture, outer pump electrode 32 may be provided with a protective layer 24. This may be developed in an open pored manner, the pore size being selected so that the gas mixture to be determined is able to diffuse into the pores of the porous layer. The pore size of the porous layer, in this instance, may be in a range of 2 to 10 μm. The porous layer is developed using a ceramic material such as the oxides of aluminum, zirconium, cerium or titanium. The porosity of the porous layer may be set appropriately, during the production of the sensor element, by the addition of pore-forming materials to the silk-screen paste, which contains the base material of porous layer 24.

In order to improve the equilibrium setting of the gas mixture that is diffusing to outer electrode 32, the protective layer additionally includes catalytically active substances. These particularly cause a reaction of oxidizing gas components of the gas mixture with reducing components.

In order to produce protective layer 24, the starting materials such as ceramic powder, pore-forming material and possibly a catalytically active component are converted to a silk-screen paste. The material of protective layer 24 is then applied to the blank of ceramic layer 23 by silk-screen printing. There then follows a heat treatment, particularly in the form of a sintering process. After the sintering process, generated porous protective layer 24 is provided with an impregnating solution, which contains at least one catalytically active substance or its precursor compound.

An additional heat treatment is then applied which leads to drying of the impregnating solution applied to the pores of protective layer 24, and possibly to the activation of the catalytically active substance or its precursor compounds. For this, sensor element 10 is brought to a temperature at which the solvent of the impregnating solution evaporates, and a coating of catalytically active substance forms in the pores of protective layer 24.

As the catalytically active substance, the impregnating solution used contains noble metals such as palladium, ruthenium or platinum, platinum may be contained at a minimum concentration of 0.0096 mol/l. The impregnating solution may alternatively, or in addition, contain compounds of an alkali metal, such as especially lithium, potassium, rubidium or cesium, or of an earth alkali metal, such as especially magnesium, calcium, strontium or barium.

A particularly high catalytic activity of the resulting coating in the pores of protective layer 24 may be achieved if alkali metal compounds and alkaline earth metal compounds are used in a mixture with platinum or palladium. It has also proven especially favorable if barium and rubidium or barium and cesium are not used in the same impregnating solution. In one additional advantageous specific embodiment, barium is used in a mixture with an aluminum compound, which may be a mixture ratio of 1:4 to 1:8, especially of 1:6 being selected.

The alkali or alkaline earth compounds are added, in this instance, in a concentration range of 0.1 to 1.6 mol/l to the impregnating solution, whereas, by contrast, the noble metal compounds are provided at a concentration of 0.096 to 0.4 mol/l in the impregnating solution.

Table 1 lists experimental results, each of the impregnating solutions shown there, for impregnating the protective layer of a standard lambda probe, being drawn upon, and as a measure for the catalytic activity of the resulting protective layer, the signal constancy of the lambda probes after a continuous test or after a greater number of changes in the composition of the gas mixture from a fuel-rich, rich exhaust gas to an oxygen-rich, lean exhaust gas being determined, and the reverse. As a control, the signal constancy of a standard lambda probe without impregnation was determined (Experiment 77). As a measure of signal constancy, that lambda value of a gas mixture was recorded at which the test lambda probes showed a measured voltage of 450 V, which would theoretically correspond to a lambda value of 1

TABLE 1

| Test | | Alk. | Noble | | |
|---|---|---|---|---|---|
| No. | Alkali | Earth | Metal | Heat in | Lambda Value |
| 4 | K | Mg² | | air | 1.0032-1.0057 |
| 7 | K | Ba/Al | Pd³ | forming gas | 1.0015-1.0035 |
| 8 | K | Ba² | Pd³ | forming gas | 1.0030-1.0045 |
| 9 | Li² | Ba² | Pd³ | forming gas | 1.0020-1.0030 |
| 10 | Rb² | Ba² | Pd³ | air | 1.0020-1.0035 |
| 11 | Rb² | Ba² | Pd³ | forming gas | 1.0020-1.0025 |
| 12 | Rb² | Ca | Pd³ | air | 1.0015-1.0025 |
| 13 | Rb² | Mg² | Pd³ | air | 1.0020-1.0035 |
| 14 | Rb² | Sr | Pd³ | air | 1.0015-1.0035 |
| 15 | Li¹ | Ba/Al | Pd³/Rh³ | air | 1.0015-1.0025 |
| 16 | Li¹ | Ba² | Pd³/Rh³ | air | 1.0015-1.0025 |
| 17 | | Mg² | Pd³/Rh³ | forming gas | 1.0010-1.0015 |
| 18 | K | Sr | Pd³/Rh³ | forming gas | 1.0005-1.0035 |
| 19 | Li² | Sr | Pd³/Rh³ | air | 1.0005-1.0020 |
| 20 | Cs | Ca | Pt³/Pd³ | forming gas | 1.0010-1.0020 |
| 21 | Li² | Ca | Pt³/Pd³ | forming gas | 1.0005-1.0015 |
| 22 | Rb² | Mg² | Pt³/Pd³ | air | 1.0020-1.0025 |
| 23 | Li¹ | | Pt³/Pd³ | forming gas | 1.0020-1.0030 |
| 24 | | Sr | Pt³/Pd³ | air | 1.0005-1.0030 |
| 27 | Li¹ | Ba³ | Pt³/Rh³ | forming gas | 1.0030-1.0040 |
| 28 | Li¹ | Ca | Pt³/Rh³ | air | 1.0040-1.0055 |
| 29 | | Mg² | Pt³/Rh³ | air | 1.0010-1.0020 |
| 30 | | Mg² | Pt³/Rh³ | air | 1.0020-1.0025 |
| 31 | K | | Pt³/Rh³ | forming gas | 1.0015-1.0035 |
| 36 | Cs | Mg² | Pt³ | forming gas | 1.0035-1.0045 |
| 37 | Li² | Mg² | Pt³ | air | 1.0020-1.0030 |
| 38 | K | | Pt³ | air | 1.0025-1.0035 |
| 39 | Rb² | Sr | Pt³ | forming gas | 1.0030-1.0045 |
| 40 | K | Ba/Al | Pt³ | air | 1.0025-1.0035 |
| 41 | | Ba/Al | Pt3 | air | 1.0015-1.0020 |
| 43 | Li¹ | Mg² | Pt³ | forming gas | 1.0010-1.0025 |
| 44 | K | Mg² | Pt³ | air | 1.0020-1.0035 |
| 45 | Li² | | Pt³ | air | 1.0030-1.0045 |
| 46 | Rb² | | Pt³ | forming gas | 1.0020-1.0045 |
| 47 | Cs | Sr | Pt³ | air | 1.0020-1.0040 |
| 48 | | Sr | Pt³ | air | 1.0020-1.0035 |
| 49 | Li¹ | Ba² | Pt² | forming gas | 1.0020-1.0035 |
| 50 | | Ba³ | Pt² | air | 1.0025-1.0035 |
| 51 | | Ca | Pt² | forming gas | 1.0020-1.0030 |
| 52 | Rb² | Mg² | Pt² | air | 1.0015-1.0025 |
| 53 | Cs | Mg² | Pt² | forming gas | 1.0010-1.0020 |
| 54 | Rb² | | Pt² | air | 1.0020-1.0025 |
| 55 | Li² | Ba/Al | Pt³/Pd³/Rh³ | forming gas | 1.0010-1.0020 |
| 56 | | Ba² | Pt³/Pd³/Rh³ | air | 1.0010-1.0030 |
| 57 | K | Ba³ | Pt³/Pd³/Rh³ | air | 1.0015-1.0025 |
| 58 | Li² | Ba³ | Pt³/Pd³/Rh³ | forming gas | 1.0010-1.0020 |
| 59 | Rb² | Ba³ | Pt³/Pd³/Rh³ | air | 1.0025-1.0035 |
| 60 | K | Ca | Pt³/Pd³/Rh³ | air | 1.0010-1.0020 |
| 61 | Rb² | Mg² | Pt³/Pd³/Rh³ | forming gas | 1.0025-1.0035 |
| 62 | Li¹ | Mg² | Pt³/Pd³/Rh³ | forming gas | 1.0005-1.0015 |
| 63 | Li² | Mg² | Pt³/Pd³/Rh³ | forming gas | 1.0010-1.0025 |
| 64 | Rb² | | Pt³/Pd³/Rh³ | forming gas | 1.0030-1.0040 |
| 72 | Li¹ | Mg² | Pt³ | air | 1.0030-1.0045 |
| 73 | Li¹ | Mg² | Pt³ | air | 1.0020-1.0035 |
| 74 | Li¹ | Mg^{2.} | Ru³ | forming gas | 1.0035-1.0085 |
| 75 | Li¹ | Mg² | Pt³/Ru³ | forming gas | 1.0015-1.0025 |
| 77 | | | | air | 1.0050-1.0115 |

| | |
|---|---|
| | c [mol/1] |
| 1_{:} | c ≧ 1 |
| 2_{:} | 0.2 < c < 1 |
| 3_{:} | c ≦ 0.1 |

Impregnating porous layer 24 with the compounds named in Table 1 leads to porous layers which have a platinum content of ca. 1.5 to 8 wt. %, particularly 2 to 4.5%, a lithium proportion or rubidium proportion of ca. 0.1 to 10 wt. %, particularly 0.2 to 4.5%, a proportion of magnesium of ca. 0.5 to 9%, particularly 0.8 to 4.5 wt. % and/or a barium proportion of ca. 0.1 to 3.5 wt. %, particularly 0.2 to 2.2 wt. %. Furthermore, or alternatively, porous layer 24 may contain ca. 0.1 to 10 wt. %, particularly 0.2 to 3.5 wt. % of one of the platinum metals ruthenium, rhodium or palladium and/or ca. 0.1 to 15 wt. %, particularly 0.8 to 9.8 wt. % of one of the elements potassium, cesium, calcium and strontium.

Porous layer 24 is not only suitable as a protective layer for electrodes of sensor elements, but also, for example, as a diffusion barrier within a sensor element, to bring about catalytically an equilibrium setting of a gas mixture diffusing into the inside of the sensor element. Sensor elements which have a porous layer designed according to the exemplary embodiments and/or exemplary methods of the present invention may be used, besides determining oxygen, also for determining gases such as nitrogen oxides, sulfur oxides, ammonia or hydrocarbons, which may be in the exhaust gases of internal combustion engines.

To do this, the described layer construction of the sensor element may contain additional solid electrolyte layers, insulation layers or functional layers.

1-15. (canceled)

16. A sensor element for a gas sensor for determining gas components of a gas mixture of exhaust gases of an internal combustion engine, comprising:
at least one electrochemical measuring cell; and
at least one porous layer that is exposed to the gas mixture, wherein the porous layer contains at least one of palladium, platinum, ruthenium, an alkali metal and an alkaline earth metal, the platinum being contained at a minimum concentration of 1.5 wt. % in the porous layer.

17. The sensor element of claim 16, wherein pores of the porous layer have at least partially a catalytically active coating whose material composition deviates from a material composition of the porous layer, and wherein the coating contains at least one of palladium, platinum, ruthenium, an alkali metal and an alkaline earth metal.

18. The sensor element of claim 16, wherein the porous layer covers an electrode of the sensor element as a protective layer at least from place to place.

19. The sensor element of claim 16, wherein the porous layer is provided on an outer surface of the sensor element that is exposed to the gas mixture.

20. A method for producing a sensor element, the method comprising:
applying a pasty mixture of ceramic material with a pore-forming material to a ceramic substrate of a sensor element to produce a porous layer;
submitting the substrate to a first heat treatment and drying it, the porous layer created being impregnated using an impregnating solution which contains at least one of platinum at a minimum concentration of 0.2 mol/l, palladium, ruthenium, and alkali metal and an alkaline earth metal; and
submitting the substrate to a second heat treatment;
wherein the sensor element is for a gas sensor for determining gas components of a gas mixture of exhaust gases of an internal combustion engine, and includes:
at least one electrochemical measuring cell, and
at least one porous layer that is exposed to the gas mixture, wherein the porous layer contains at least one of palladium, platinum, ruthenium, an alkali metal and an alkaline earth metal, the platinum being contained at a minimum concentration of 1.5 wt. % in the porous layer.

21. The method of claim 20, wherein the second heat treatment takes place in an atmosphere of a forming gas.

22. The method of claim 20, wherein the pasty mixture contains up to 2 wt. % of platinum.

23. An impregnating solution for producing a sensor element, comprising:
at least one of platinum at a minimum concentration of 0.2 mol/l, palladium, ruthenium, and alkali metal and an alkaline earth metal;
wherein the sensor element is for a gas sensor for determining gas components of a gas mixture of exhaust gases of an internal combustion engine, and includes:
at least one electrochemical measuring cell, and
at least one porous layer that is exposed to the gas mixture, wherein the porous layer contains at least one of palladium, platinum, ruthenium, an alkali metal and an alkaline earth metal, the platinum being contained at a minimum concentration of 1.5 wt. % in the porous layer.

24. The impregnating solution of claim 23, wherein the solution contains one of alkali metal, alkaline earth metal, palladium, ruthenium and platinum in a non-elemental form.

25. The impregnating solution of claim 23, wherein the solution does not contain simultaneously barium and one of rubidium and cesium.

26. The impregnating solution of claim 23, wherein the solution contains barium and aluminum in a ratio of 1:2 through 1:8.

27. The impregnating solution of claim 23, wherein the solution contains palladium, ruthenium or platinum in a concentration of 0.05 to 0.4 mol/1.

28. The impregnating solution of claim 23, wherein the solution contains one of an alkali metals and an alkaline earth metal in a concentration of 0.2 to 2.5 mol/l.

29. The impregnating solution of claim 23, wherein the solution additionally contains rhodium.

30. The impregnating solution of claim 23, wherein the solution contains at least one of an alkali metal and an alkaline earth metal, and also contains at least one of platinum and palladium.
